(19) United States
(12) Patent Application Publication
(10) Pub. No.: US 2025/0256881 A1
(43) Pub. Date: Aug. 14, 2025

(54) CONTAINER

(71) Applicant: Gaplast GmbH, Altenau (DE)

(72) Inventors: Stephan Kneer, Farchant (DE); Kasim Yilginc, Oberammergau (DE)

(21) Appl. No.: 19/006,473

(22) Filed: Dec. 31, 2024

(30) Foreign Application Priority Data
Feb. 9, 2024 (DE) 10 2024 103 699.0

(51) Int. Cl. B65D 1/02

(52) U.S. Cl. CPC B65D 1/0284; B65D 1/0207

(57) ABSTRACT

A container including a stiff outer container and a deformable inner bag where the inner bag has a preform consisting of at least two tubes coextruded and arranged between the open halves of a blow mold, where the blow mold is closed when the preform has the length necessary for the production of the container, and excess material from the base region of the container to be produced is squeezed out and a pinch seam is formed from fused material of the outer container. The pinch seam at the base of the container has a non-linear shape and is longer than with a linear shape and that due to the opening of the blow mold, minute air slit openings are formed in the seam of the outer container, through which ambient air enters into the gap between the inner bag and the outer container for pressure balancing purposes.

### PRIORITY CLAIM

The subject application claims convention priority to German patent application No. DE 10 2024 103 699.0, filed Feb. 9, 2024.

### BACKGROUND

The invention relates to a container, which consists of a stiff outer container and a deformable inner bag of thermoplastic plastic materials which do not form a weld connection with one another, with a container opening, wherein a preform consisting of at least two tubes is coextruded and is arranged between the open halves of a blow mould and the blow mould is closed when the preform has the length necessary for the production of the container, wherein excess material in the base region of the container to be produced is squeezed out and a pinch seam is formed from fused material of the outer container, in which the non-fused base seam of the inner bag is clamped and is held in the axial direction and wherein the preform is inflated by a pressure medium into engagement with the wall of the blow mould and is removed after opening the blow mould.

The different types of thermoplastic plastic materials of the outer container and the inner bag form no weld connection with one another but they adhere to one another when the container is produced in a coextrusion process. Before such a container is capable of use, i.e. is filled with a, for instance, liquid or pasty container content, which is then gradually dispensed, e.g. by means of an airless pump or by compressing the container, the inner bag must be released from the wall of the outer container and then applied to it again. This can be effected e.g. by applying a reduced pressure to the inner bag through the container opening which thereupon contracts. Compressed air can then be introduced into the inner bag through the container opening in order to apply it again to the outer container. When the inner bag contracts during the release, described above, from the outer container, ambient air must flow into the gap between the outer container and the inner bag for pressure balancing purposes so that the inner bag can contract. The same is also the case when dispensing the container contents when the container is used in the intended manner.

In order to enable this pressure balance, it is known to form wall openings in the outer container, for which purpose different techniques have been developed with which damage to the thin inner bag is avoided. This formation of wall openings in the outer container necessitates a complex working step in the manufacture of the container, which not only increases the manufacturing time but is also reflected in additional costs.

It is the object of the present invention to further develop a container of the type under consideration so that it is capable of being used without the subsequent formation of a wall opening in the outer container.

### SUMMARY

The container in accordance with the invention has a lengthened pinch seam on the base. This pinch seam does not extend in a straight line centrally through the base region of the container, as is the case in the previously known containers of this type, but instead the pinch seam extends alternately on both sides of the previously straight line pinch seam, which bisects the base region. This pinch seam can have a toothed shape, at least over a proportion of its length, which preferably extends on alternating sides of the central line of the base of the container. The pinch seam can also have a wave shape, which can correspond to a sinusoidal curve, or also extend in a step shape on alternating sides, preferably over the entire length of the pinch seam.

### BRIEF DESCRIPTION OF THE DRAWINGS

FIG. 1 is a cross-sectional view of an embodiment of the present container.

FIG. 2 is a bottom view of the base of the container of FIG. 1.

FIG. 3 is a bottom view of another embodiment of the base.

FIG. 4 is a bottom view of a further embodiment of the base.

### DETAILED DESCRIPTION

Due to the non-linear shape of the pinch seam, it has a considerably greater length, which is significant for the following reason. The applicant has discovered that as a consequence of the opening of the blow mould, minute air slit openings form in the seam of the outer container. Ambient air flows through these capillary openings into the gap between the contracting inner bag and the outer container, whereby a complete pressure balance occurs in the gap through the air slit openings. Due to the very small air slit openings, which are scarcely visible from the exterior of the container with the naked eye, the reduced pressure as a result of the dispensing of the container contents is surprisingly balanced out since sufficiently many air slit openings are formed due to the considerably greater length of the pinch seam.

The air slit openings in the pinch seam are produced in the following manner:

When the blow mould is closed, it squeezes the base region of the preform together, whereby the squeezing edge of the blow mould adheres to the hot preform. When the blow mould is opened, the opening blow mould exerts a tensional force on the pinch seam in order to free itself from the squeezed preform. The applicant has discovered that the pinch seam is pulled apart a little during this process, whereby air slit openings of capillary size form. It is possible that this effect when opening the blow mould is increased by the non-linear shape of the pinch seam, possibly particularly at the sharp edge points of a toothed or stepped shape of the pinch seam.

The requirement to form wall openings in the outer container in a complex processing step, which were previously provided in containers of the type under consideration, therefore disappears.

It can be provided with great advantage that the inner bag consists of at least two layers and the layer engaging the outer container has a rough surface with microscopic protuberances and recesses in the hardened state so that the adhesive forces between the outer container and the inner bag are minimised. The inner bag can preferably consist of a mixture of EVOH and a plastic material with elastic properties. The material component comprising EVOH has the property of forming the rough surface when solidifying or cooling down, whereby this material has the further property of a relatively large stiffness so that it is not suitable alone for a readily deformable inner bag. For this reason, the material component EVOH is mixed with a uniformly distributed plastic material with elastic characteristics. An ionomer is used with particular advantage for this purpose which is present in the EVOH in the dispersed phase. The inner layer of the inner bag can consist of LDPE, though this recitation is not limiting.

After opening the blow mould, the moulding flash below the squeezing edge is knocked off, which contributes to opening the air slit openings at the edge. The container can thereafter be transported by a conveyor, on one side of whose conveyor track a vertical, rotating conveyor belt is arranged, which runs in the same direction as the rotating conveyor belt, and on the opposite side a fixed vertical belt is arranged, whereby the distance between the rotating vertical conveyor belt and the fixed belt is somewhat smaller than the outer diameter of the containers so that the containers are rotated about their vertical axis on passing between the rotating vertical conveyor belt and the fixed vertical belt and are thereby laterally compressed, whereby the inner bags abruptly come free from the outer containers. Such an apparatus for detaching foldable inner bags from the inner walls of the associated rigid containers is known. The detaching of the inner bag from the outer container has the advantage with this procedure that only a small gap is produced in the gap between the slightly laterally compressed inner bag and the outer container when passing through the conveyor belt, which is filled without problem through the minute air slit openings with ambient air.

During use of the container and the gradual dispensing of the container contents, the inner bag gradually contracts in a star shape, whereby the pressure balance occurs through the air slit openings in the base seam.

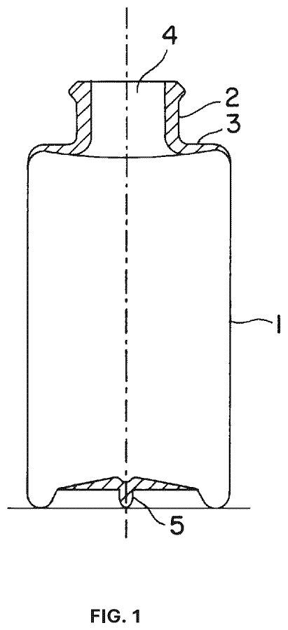

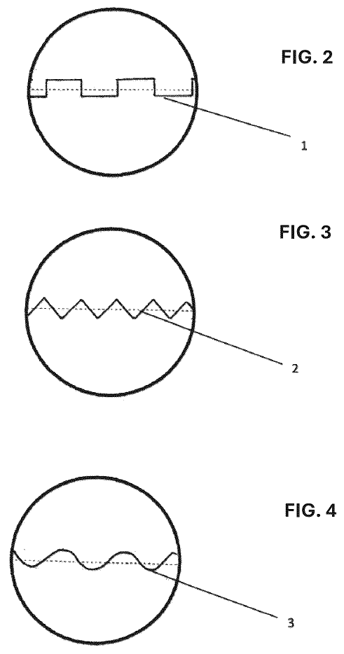

The attached FIGS. 1 to 3 show a step-shaped pinch seam 1, a toothed pinch seam 2 and a wave-shaped pinch seam 3 on the base, which are thus considerably longer than a straight line base seam.

The non-linear pinch seam stiffens the base surface, whereby the side surface is the first to become detached.

1. A container, which consists of a stiff outer container and a deformable inner bag of thermoplastic plastic materials which do not form a weld connection with one another, the container comprising:
a preform consisting of at least two tubes coextruded and arranged between the open halves of a blow mold, wherein the blow mold is closed when the preform has the length necessary for the production of the container, and wherein excess material from the base region of the container to be produced is squeezed out and a pinch seam is formed from fused material of the outer container,
wherein the welded base seam of the inner bag is clamped and held in the axial direction and the preform is inflated by a pressure medium into engagement with the wall of the blow mold and removed after opening the blow mold,
wherein the pinch seam at the base of the container has a non-linear shape and is longer than with a linear shape and that due to the opening of the blow mold, minute air slit openings are formed in the seam of the outer container, through which ambient air enters into the gap between the inner bag and the outer container for pressure balancing purposes.

2. The container as claimed in claim 1, wherein the pinch seam has a toothed shape, at least over a portion of the length of the pinch seam.

3. The container as claimed in claim 1, wherein the pinch seam has a wave shape, at least over a portion of the length of the pinch seam.

4. The container as claimed in claim 1, wherein the pinch seam has a stepped shape, at least over a portion of the length of the pinch seam.

5. The container as claimed in claim 1, wherein the pinch seam has the non-linear shape over the entire length of the pinch seam.

6. The container as claimed in claim 1, wherein the container has no subsequently formed pressure balancing openings in the wall of the outer container.

7. The container as claimed claim 1, wherein the inner bag has a rough surface on an outer side of the inner bag.

8. The container as claimed in claim 7, wherein the inner bag consists of at least two layers and that the outer layer consists of a mixture of EVOH with an elastic plastic material.
